(19) United States
(12) Patent Application Publication
(10) Pub. No.: US 2002/0186420 A1
(43) Pub. Date: Dec. 12, 2002

(54) Wireless transmission controller for image scanner and process for wirelessly communicating with image scanner

(75) Inventor: Dave Wu, Tainan City (TW)

Correspondence Address: LOWE HAUPTMAN GOPSTEIN, GILMAN & BERNER LLP, Suite 310, 1700 Diagonal Road, Alexandria, VA, 22314, US

(73) Assignee: MUSTEK SYSTEMS INC.

(21) Appl. No.: 10/015,651

(22) Filed: Dec. 17, 2001

(30) Foreign Application Priority Data
Jun. 7, 2001 (TW) 90113758

(51) Int. Cl. H04N 1/00

(52) U.S. Cl. 358/405

(57) ABSTRACT

A wireless transmission controller for transmitting data to a digital image scanner is provided. The digital image scanner has a first wireless transmission device. The wireless transmission controller includes a storage device for storing set data and first commands for the digital image scanner, an amending and triggering device for amending the data and the first commands stored in the storage device when required, and a second wireless transmission device for wirelessly transmitting the data and the commands of the final version to the first wireless transmission device. When the amending and triggering device is triggered, the digital image scanner executes actions represented by the second commands under the conditions defined by the set data.

### FIELD OF THE INVENTION

The present invention relates to a wireless transmission controller and a process for wirelessly transmitting data between a digital image scanner and the wireless transmission controller.

### BACKGROUND OF THE INVENTION

Digital image capturing apparatuses such as digital image scanners and digital cameras are widely used to process images. These images are scanned/captured and then digitized for a computer to organize, store, analyze and process their data.

Referring to FIG. 1, a typical digital image scanner 1 has some function keys 11, 12, 13, 14 and 15. Each of the function keys is employed to execute a specified task, for example scanning, printing, faxing or performing optical character recognition (OCR). Such design is not user-friendly, however, because these functions are pre-determined by manufacturers rather than the user, and thus the user should passively accept the unchanged functions. Although some digital image scanners provide additional function keys for users to set optionally, the number thereof is restricted by the panel size and the complexity of corresponding circuit arrangement. In addition, the fabricating cost and breakdown possibility of these digital image scanners will increase.

The typical digital image scanner is implemented with a personal computer. In other words, a computer is required for a user to observe the present statuses and/or set desired functions of the digital image scanner. The statuses and set functions include but are not limited to resolution (dots per inch), scanning area, photocopy number, and indication/input of electronic-mail address. Furthermore, an additional input device, for example a keyboard, a mouse, a touch screen, a voice input device, etc. and a display for realizing the input result, is required when more advanced scanning functions are to be performed. The above-mentioned conditions are not suitable in a public domain because some shortcomings will occur. For example, the setting statuses of personal preference might be altered and the secrets of the e-mail address and facsimile phone book might be impaired.

Since a computer is indispensable for the digital image scanner, the application of the scanner is restricted. For example, the user requires much attention to operate the computer when using the scanner. The computer and the digital image scanner might fully occupy the user's table. In addition, their wire linkage is very troublesome and inconvenient because an additional cable is employed to connect the computer with the digital image scanner aside from a mass of cables having been connected to the computer.

Therefore, the present invention provides wireless handheld controller and a process for transmitting data between the wireless handheld controller and a digital image scanner so as to overcome the problems described above.

### SUMMARY OF THE INVENTION

In accordance with an aspect of the present invention, there is provided a wireless transmission controller for communicating with a digital image scanner via wireless data transmission. The wireless transmission controller includes a storage device, an amending and triggering device and a wireless transmission device. The storage device is used for storing set data and set commands operative for the digital image scanner. The amending and triggering device is electrically connected to the storage device for optionally amending the set data and the set commands to be re-stored into the storage device as the set data and the set commands, and triggering the storage device to output the set commands. The wireless transmission device is electrically connected to the storage device for wirelessly transmitting the set data and the set commands to the digital image scanner to execute actions represented by the set commands in response to conditions defined by the set data.

Preferably, aid wireless transmission device is an infrared wireless transmission device or a bluetooth wireless transmission device.

Preferably, the storage device is a non-volatile memory or a hard disc.

Preferably, the amending and triggering device includes an input keypad plus a screen, wherein the keypad is electrically connected to the storage device for inputting the set data and commands, and including a plurality of keys, each of which triggers the storage device to output one of the set commands corresponding thereto, and the screen is electrically connected to the storage device for displaying amendment situations of the set data, and the set commands.

Preferably, the correcting and triggering device is a touch screen.

Preferably, the wireless transmission controller is a hand-held computer, for example a Personal Digital Assistant (PDA) or a digital mobile phone.

In accordance with another aspect of the present invention, there is provided a process for transmitting data between a digital image scanner and a wireless transmission controller, wherein the digital image scanner has a first wireless transmission device, the wireless transmission controller has a storage device, an amending and triggering device and a second wireless transmission device. The process includes steps of storing set data and first commands for the digital image scanner in the storage device, optionally amending the set data and the first commands into a newly set data and second commands by the amending and triggering device, enabling the amending and triggering device to trigger the storage device to output the second commands, and wirelessly transmitting the newly set data and the second commands from the second wireless transmission device to the first wireless transmission device such that the digital image scanner executes actions represented by the second commands according to conditions defined by the set data.

In accordance with still another aspect of the present invention, there is provided a storage medium readable by a wireless transmission controller for executing a process of transmitting data between a digital image scanner and a wireless transmission controller. The process includes steps of setting and storing first data and first commands, amending the first data and the first commands into second data and second commands according to a requirement of a user, wirelessly transmitting the second data and the second commands from the wireless transmission controller to the digital image scanner, and controlling the digital image scanner to perform one of the second commands in response to a selecting operation of a user under conditions set by the second data.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a perspective view illustrating a typical scanner with some functional keys;

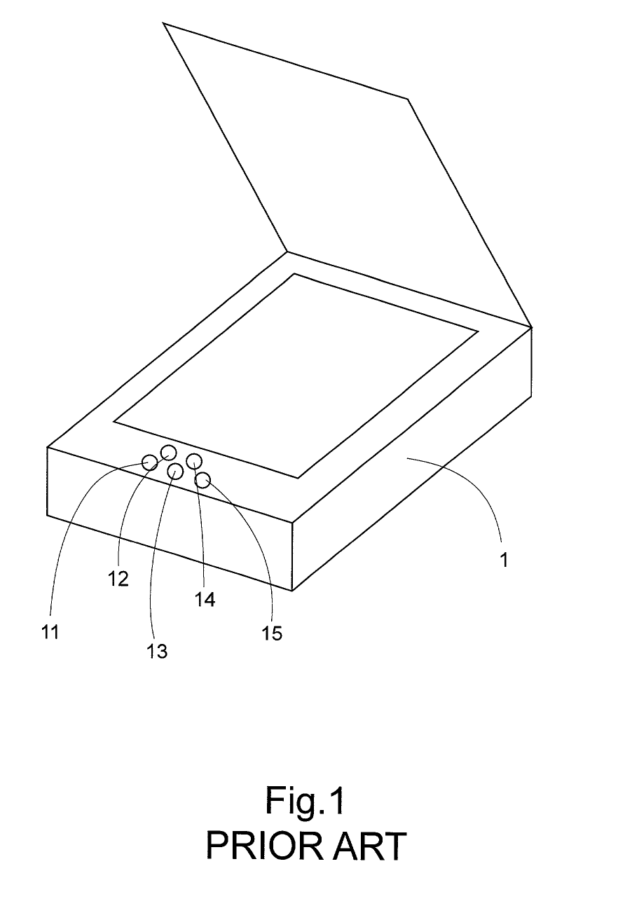

FIG. 2 is schematic view illustrating the transmission between a digital image scanner and a wireless transmission controller according to a first preferred embodiment of the present invention; and

FIG. 3 is schematic view illustrating the transmission between a digital image scanner, a computer and a wireless transmission controller according to a second preferred embodiment of the present invention.

### DETAILED DESCRIPTION OF THE PREFERRED EMBODIMENT

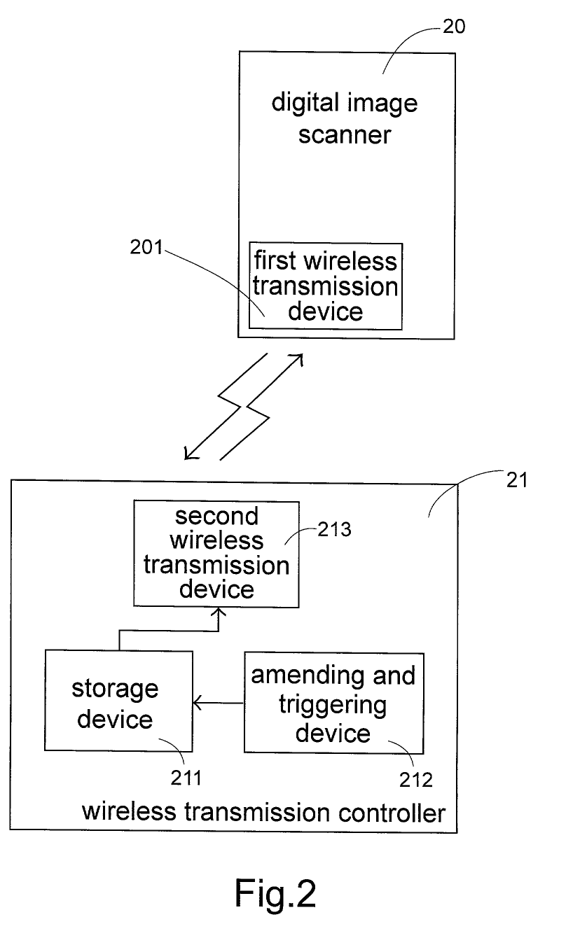

FIG. 2 is a schematic view illustrating the relation between a digital image scanner 20 and a wireless transmission controller 21 according to a preferred embodiment of the present invention. The digital image scanner 20 is equipped with a first wireless transmission device 201. The wireless transmission controller 21 includes a storage device 211, an amending and triggering device 212 and a second wireless transmission device 213. The storage device 211 is used for storing predetermined data and a plurality of commands. The predetermined data include but are not limited to settings of resolution (dots per inch), scanning area and photocopy number, and indication/input of electronic-mail address. The commands include but are not limited to “faxing after scanning”, “e-mail transmitting after scanning”, and “printing after scanning”. The amending and triggering device 212, which could be an input keypad plus a screen (not shown), is provided for a user to reset the predetermined data and commands. Moreover, the amending and triggering device 212 is selectively triggered to allow the storage device 211 to output a corresponding command. The second wireless transmission device 213 is employed for wirelessly transmitting such command to the first wireless transmission device 201 of the digital image scanner 20. The digital image scanner 20 will execute the actions according to the corresponding command and the conditions defined by the predetermined data.

It is of course that the digital data obtained from the digital image scanner 20, i.e. by scanning, can be transmitted from the first wireless transmission device 201 thereof to one or more wireless transmission controllers via respective first wireless transmission devices.

Preferably, each of the first wireless transmission devices 201 and the second transmission device is an infrared transmission device in accordance with the IrDA (Infrared Data Association) requirements or an electromagnetic wireless transmission device in accordance with the bluetooth requirement.

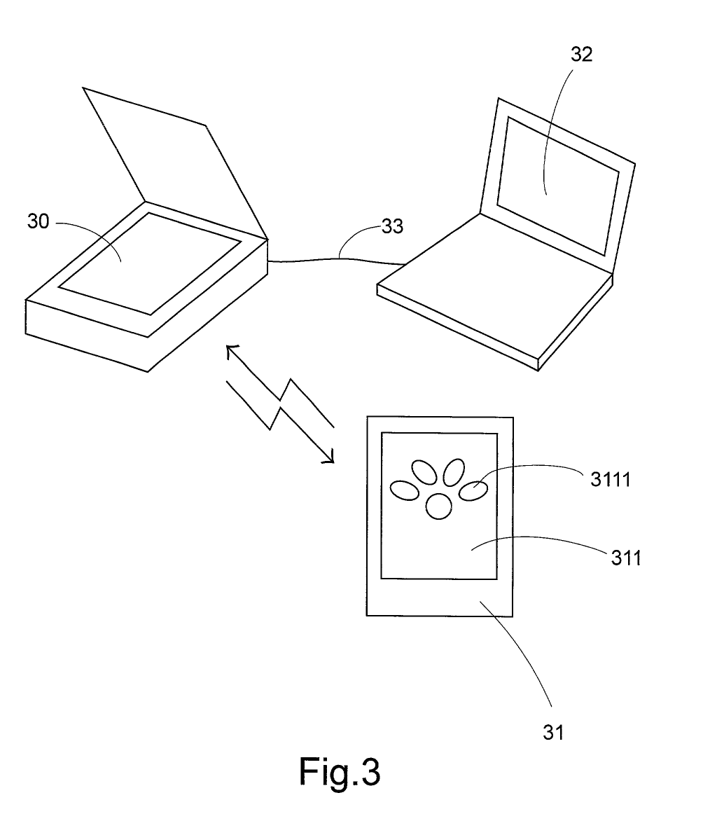

FIG. 3 is a schematic view illustrating the data transmission between a computer 32, a digital image scanner 30 and a wireless transmission controller 31 according to another preferred embodiment of the present invention. The wireless transmission controller 31 of the present invention is preferably a handheld computer, such as a Personal Digital Assistant (PDA) or a digital mobile phone equipped with PDA functions.

The wireless transmission controller 31, for example a Personal Digital Assistant, has a touch screen 311 of a liquid crystal display. The touch screen 311, analogous to the amending and triggering device 211, is used for inputting the predetermined data and commands. In addition, on the touch screen 311, a plurality of virtual function keys 3111 can be built through a write-in software of the Personal Digital Assistant 31. When one of these function keys 3111 is triggered, the storage device such as a hard disc or a non-volatile memory mounted within the Personal Digital Assistant 31 outputs a corresponding command.

Referring to FIG. 3, the digital data obtained, i.e. by scanning, can be wirelessly transmitted to one or more Personal Digital Assistants 31. Also, such digital data can be transmitted to the computer 32 via a cable 33. Certainly, the digital data can be further processed by the computer 32, for example by being converted into a text file via optical character recognition (OCR), then transmitted to the image digital scanner 30, and finally wirelessly transmitted to one or more Personal Digital Assistants 31. It is of course that the digital data can be processed by the digital image scanner 31, for example by being converted into a text file via optical character recognition (OCR), and subsequently wirelessly transmitted to one or more Personal Digital Assistants 31.

The wireless transmission controller of the present invention is implemented by a hand-held computer which is equipped with a write-in software and a touch screen 311 for amending and triggering the data and commands. The virtual function keys 3111 on the touch screen 311 can be determined in accordance with the demand of the user. In addition, no concrete function keys are needed, thereby reducing the fabricating cost. Certainly, the write-in software can be stored in a storage media (such as a compact disk) and available from the scanner manufacturer together with the scanner assembly. In addition, it is very advantageous that the statuses and set functions of the digital image scanner, for example settings of dots per inch, scanning area and photocopy number, and indication/input of electronic-mail address, can be examined through the wireless transmission controller of the present invention. Furthermore, different users can have their own wireless transmission controllers so as to wirelessly connect with a digital image scanner in a public domain without altering or impairing others' setting statuses of personal preference. Advantageously, the wireless transmission controller of the present invention is implemented by means of wireless transmission such that no cable is required to connect with the digital image scanner. Also, less space is occupied because the wireless transmission controller of the present invention is of a hand-held size.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless transmission controller for communicating with a digital image scanner via wireless data transmission, said wireless transmission controller comprising:
a storage device for storing set data and set commands operative for said digital image scanner;
an amending and triggering device electrically connected to said storage device for optionally amending said set data and said set commands to be re-stored into said storage device as said set data and said set commands, and triggering said storage device to output said set commands; and
a wireless transmission device electrically connected to said storage device for wirelessly transmitting said set data and said set commands to said digital image scanner to execute actions represented by said set commands in response to conditions defined by said set data.

2. The wireless transmission controller according to claim 1 wherein said wireless transmission device is an infrared wireless transmission device.

3. The wireless transmission controller according to claim 1 wherein said wireless transmission device is a bluetooth wireless transmission device.

4. The wireless transmission controller according to claim 1 wherein said storage device is a non-volatile memory.

5. The wireless transmission controller according to claim 1 wherein said storage device is a hard disc.

6. The wireless transmission controller according to claim 1 wherein said amending and triggering device comprises:
an input keypad electrically connected to said storage device for inputting said set data and commands, and including a plurality of keys, each of which triggers said storage device to output one of said set commands corresponding thereto; and
a screen electrically connected to said storage device for displaying amendment situations of said set data, and said set commands.

7. The wireless transmission controller according to claim 1 wherein said correcting and triggering device is a touch screen.

8. The wireless transmission controller according to claim 1 wherein said wireless transmission controller is a hand-held computer.

9. The wireless transmission controller according to claim 1 wherein said wireless transmission controller is a Personal Digital Assistant (PDA).

10. The wireless transmission controller according to claim 1 wherein said wireless transmission controller is a digital mobile phone.

11. A process for transmitting data between a digital image scanner and a wireless transmission controller, said digital image scanner having a first wireless transmission device, said wireless transmission controller having a storage device, an amending and triggering device and a second wireless transmission device, said process comprising steps of:
storing set data and first commands for said digital image scanner in said storage device;
optionally amending said set data and said first commands into a newly set data and second commands by said amending and triggering device;
enabling said amending and triggering device to trigger said storage device to output said second commands; and
wirelessly transmitting said newly set data and said second commands from said second wireless transmission device to said first wireless transmission device such that said digital image scanner executes actions represented by said second commands according to conditions defined by said set data.

12. The process according to claim 11 wherein each of said first wireless transmission device and said second wireless transmission device is an infrared wireless transmission device.

13. The process according to claim 11 wherein each of said first wireless transmission device and said second wireless transmission device is a bluetooth wireless transmission device.

14. The process according to claim 11 wherein said amending and triggering device is a touch screen.

15. The process according to claim 11 wherein said wireless transmission controller is a hand-held computer.

16. The process according to claim 15 wherein said hand-held computer is one of a Personal Digital Assistant (PDA) and a digital mobile phone.

17. A storage medium readable by a wireless transmission controller for executing a process of transmitting data between a digital image scanner and a wireless transmission controller, said process comprising steps of:
setting and storing first data and first commands;
amending said first data and said first commands into second data and second commands according to a requirement of a user;
wirelessly transmitting said second data and said second commands from said wireless transmission controller to said digital image scanner; and
controlling said digital image scanner to perform one of said second commands in response to a selecting operation of a user under conditions set by said second data.

18. The storage medium according to claim 17 wherein said amending and triggering device is a touch screen.

19. The storage medium according to claim 17 wherein said wireless transmission controller is a hand-held computer.

20. The storage medium according to claim 19 wherein said hand-held computer is one of a Personal Digital Assistant (PDA) and a digital mobile phone.
